(19) United States
(12) Patent Application Publication
(10) Pub. No.: US 2010/0266296 A1
(43) Pub. Date: Oct. 21, 2010

(54) IMAGE FORMING APPARATUS AND IMAGE QUALITY MAINTENANCE METHOD FOR IMAGE FORMING APPARAUTS

(75) Inventor: Norikazu Ochiai, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/760,729

(22) Filed: Apr. 15, 2010

Related U.S. Application Data
(60) Provisional application No. 61/170,902, filed on Apr. 20, 2009.

(51) Int. Cl. G03G 15/08; G03G 15/00

(52) U.S. Cl. 399/27; 399/49; 399/43

(57) ABSTRACT

An image forming apparatus has a photoconductive drum which carries an electrostatic latent image, a developer supply unit which supplies a developer to the photoconductive drum, an image carrier which carries a developer image, and a density sensor which measures a density of a test print on the image carrier. The image forming apparatus carries out a second image quality maintenance operation for lowering a contrast potential when the density of the test print is higher than a predetermined value. When the test print is still dense even if the contrast potential reaches a lower limit value, the image forming apparatus carries out a first image quality maintenance operation for discharging the developer, then supplying a fresh developer to the developer supply unit, and causing the developer to be stirred and thus charged.

### CROSS-REFERENCE TO RELATED APPLICATIONS

This application is based upon and claims the benefit of priority from the prior the U.S. Patent Application No. 61/170,902, filed on 20 Apr., 2009, the entire contents of which are incorporated herein by reference.

### TECHNICAL FIELD

The present invention relates to an image forming apparatus having an improved image quality maintenance capability to maintain good image quality of printing, and an image quality maintenance method for an image forming apparatus.

### BACKGROUND

In an image forming apparatus such as a copier, MFP (multi-function peripheral) or printer, image quality may deteriorate if printing is not carried out. Moreover, even if printing is carried out, image quality may deteriorate as the number of sheets on which printing is continuously carried out increases. One of the causes of this deterioration is the reduction in the quantity of charging of the developer.

In connection with this point, a technique of measuring a time period during which printing is not carried out, then stirring a developer if this measured time period exceeds a preset time and thereby increasing the quantity of charging of the developer to a predetermined value is proposed, for example, as disclosed in JP-A-2003-57890.

However, even this technique has a problem that if the charging ability of the developer is lowered, the quantity of charging cannot be increased to a predetermined value by stirring of the developer and therefore image quality deteriorates.

### SUMMARY

It is an object of the invention to provide an image forming apparatus that can maintain image quality even when a contrast potential as a difference between a potential of an electrostatic latent image on a photoconductive drum and a potential of a developing roller reaches a lower limit value.

According to an aspect of the invention, an image forming apparatus which forms an image on a carried recording medium includes:

an image carrier which carries an electrostatic latent image;

a developer supply unit having a stirring member which stirs a developer and a developer roller which supplies the developer to the image carrier;

a developer image carrier which carries a developer image that is formed as the developer is supplied to the electrostatic latent image;

a cleaning unit which collects the developer on the image carrier;

a density sensor which measures a density of a test print on the developer image carrier; and

a controller which, if the density of the test print measured by the density sensor is higher than a predetermined value, carries out a first image quality maintenance operation of discharging a part of the developer in the developer supply unit, then supplying a fresh developer to the developer supply unit, and causing the stirring member to stir and charge the supplied fresh developer.

### DESCRIPTION OF THE DRAWINGS

FIG. 1 shows the configuration of an image forming apparatus according to the invention.

FIG. 2 is an enlarged view showing the periphery of a transfer unit according to the invention.

FIG. 3 shows an example of patches according to the invention.

FIG. 4 is a schematic view showing the configuration of the image forming apparatus according to the invention.

FIG. 5 is a flowchart showing an image quality maintenance operation in the image forming apparatus according to the invention.

FIG. 6 is a graph showing the relation between the quantity of charging of a developer and leaving time in a conventional image forming apparatus.

FIG. 7 is a graph showing the relation between the quantity of charging of a developer and leaving time in the image forming apparatus according to the invention.

### DETAILED DESCRIPTION

Throughout this description, the embodiments and examples shown should be considered as exemplars, rather than limitations on the apparatus and methods of the present invention.

Hereinafter, an embodiment of an image forming apparatus and an image quality maintenance method for an image forming apparatus according to the invention will be described in detail with reference to the drawings.

### Configuration of Image Forming Apparatus

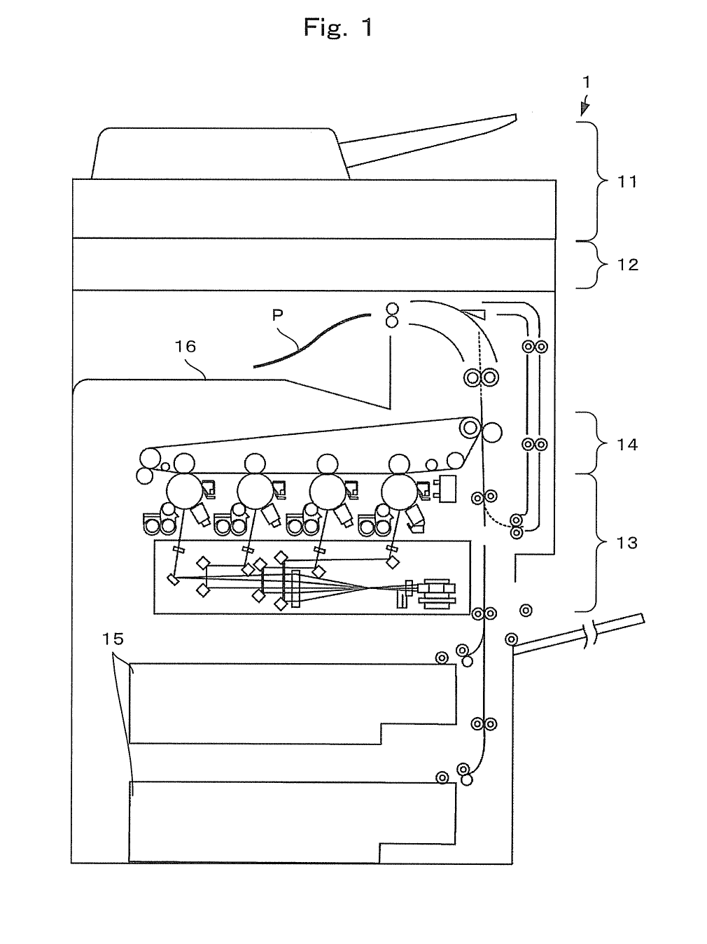

FIG. 1 shows the configuration of an image forming apparatus 1 according to this embodiment. As shown in FIG. 1, the image forming apparatus 1 includes an automatic document feeder 11, an image scanning unit 12, an image forming unit 13, a transfer unit 14, a sheet carrying mechanism, and a paper supply unit 15.

The automatic document feeder 11 is installed on top of the body of the image forming apparatus 1 in such a manner that the automatic document feeder 11 can open and close freely. The automatic document feeder 11 has a document carrying mechanism which takes out sheets of a document one by one from a paper supply tray and carries the document to a paper discharge tray.

The automatic document feeder 11 with its document carrying function carries sheets of a document one by one to a document scanning section of the image scanning unit 12. It is also possible to open the automatic document feeder 11 and place a document on a document table of the image scanning unit 12.

The image scanning unit 12 has a carriage having an exposure lamp to expose a document to light and a first reflection mirror, plural second reflection mirrors installed on a body frame of the image forming apparatus 1, a lens block, and a CCD (charge coupled device) of an image scanning sensor.

The carriage stands still in the document scanning section or reciprocates below the document table and thus causes the first reflection mirror to reflect the light of the exposure lamp that is reflected by the document. The plural second reflection mirrors reflect the reflected light from the first reflection mirror to the lens block. The lens block varies the magnification of the reflected light and outputs the resulting light to the CCD. The CCD converts the incident light to an electrical signal and outputs the electrical signal as an image signal to the image forming unit 13.

The image forming unit 13 has a laser irradiation unit, a photoconductive drum as an image carrier, and a developer supply unit.

The laser irradiation unit irradiates the photoconductive drum with a laser beam in accordance with the image signal and thus forms an electrostatic latent image on the photoconductive drum. The developer supply unit supplies a developer to the photoconductive drum and forms a developer image based on the electrostatic latent image.

The paper supply unit 15 takes out recording media one by one from a paper supply cassette and delivers each recording medium to the sheet carrying mechanism. The sheet carrying mechanism carries the recording medium to the transfer unit 14.

The transfer unit 14 has a transfer belt, a transfer roller, and a fixing device. The transfer belt, as a developer image carrier, has the developer image on the photoconductive drum transferred thereto and carries the developer image. The transfer roller applies a voltage and transfers the developer image on the transfer belt to the recording medium carried thereto. The fixing device heats and pressurizes the developer image and thus fixes the developer image to the recording medium.

A recording medium P discharged from a paper discharge port is stacked on a paper discharge tray 16 as a carrier unit which carries recording media.

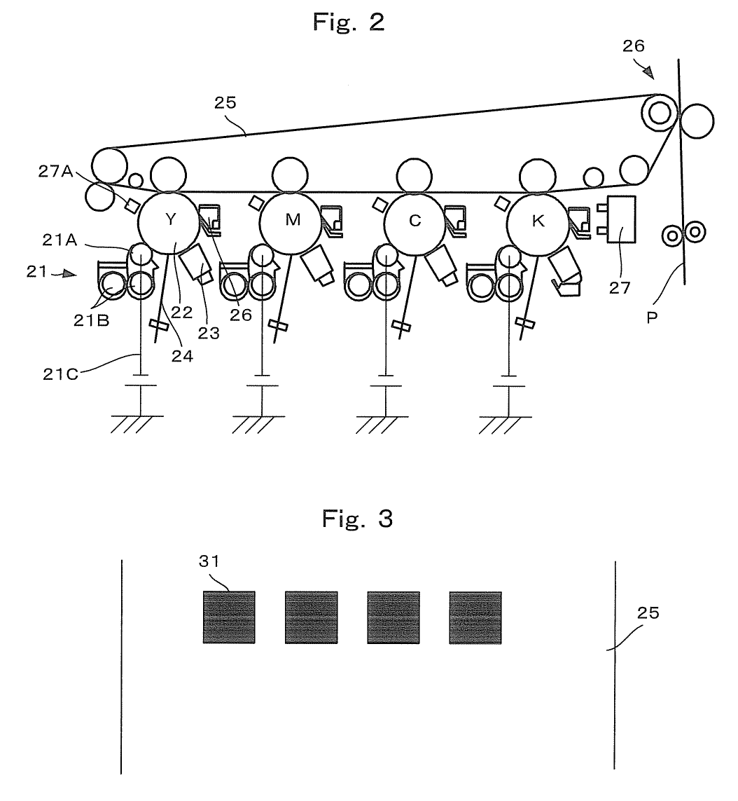

FIG. 2 is an enlarged view showing the periphery of the transfer unit 14. As shown in FIG. 2, the image forming apparatus 1 has a photoconductive drum 22 which receives a laser beam 24, a charging device 23 which charges the photoconductive drum 22, a developer supply unit 21, and a cleaning unit 26 which collects a developer from the photoconductive drum 22, for each of the four colors of yellow Y, magenta M, cyan C, and block K.

The charging device 23 applies a voltage to the photoconductive drum 22 and charges the photoconductive drum 22 to −600 V. When the photoconductive drum 22 is irradiated with the laser beam 24, the quantity of charging in the irradiated part changes to around −100 V. The part with the changed quantity of charging forms an electrostatic latent image.

The developer supply unit 21 has a stirring member 21B which stirs a developer and thus charges the developer, a developer roller 21A which supplies the charged developer to the photoconductive drum 22, and a voltage section 21C which applies a developing bias voltage to the developer roller 21A.

A voltage of −450 V is applied to the developer roller 21A. Therefore, the developer adheres to the positively biased site of −100 V compared with the site of −450 V on the photoconductive drum 22, that is, to the electrostatic latent image, and thus forming a developer image.

The developer image is then transferred to a transfer belt 25. Moreover, the developer image is heated and pressurized by the fixing roller and thus fixed to the recording medium P from the transfer belt 25.

The image forming apparatus 1 also has a density sensor 27 downstream of the photoconductive drum 22 in the turning direction of the transfer belt. The density sensor 27 detects the density of patches 31 as a test print transferred to the transfer belt 25.

FIG. 3 shows an example of the patches 31. As shown in FIG. 3, as the patches 31, developer images corresponding to the kinds of the colors of the developers are formed and transferred to the transfer belt 25. The patches 31 are formed with maximum density, that is, by solid printing.

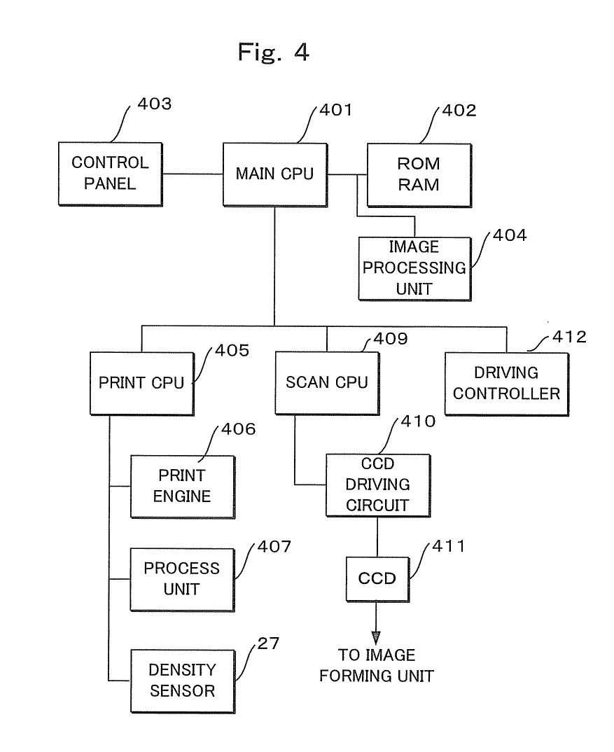

FIG. 4 is a schematic view showing the configuration of the image forming apparatus 1. As shown in FIG. 4, the image forming apparatus 1 has a main CPU 401 as an arithmetic unit which performs overall control of the entire image forming apparatus 1, a control panel 403 connected to the main CPU 401, a ROM and RAM 402 as a storage unit, and an image processing unit 404 which performs image processing.

The main CPU 401 also functions as an elapsed time measuring unit which measures a time period for which the apparatus is not continuously used. The main CPU 401 also functions as a number of image forming sheets counting unit which counts the number of sheets on which image formation is continuously carried out.

The main CPU 401 is connected to a print CPU 405 as a controller which controls each part of an image forming system, a scan CPU 409 which controls each part of an image scanning system, and a driving controller 412 which controls a driving unit.

The print CPU 405 controls a print engine 406 which forms an electrostatic latent image on the photoconductive drum 22, and a process unit 407 which forms a developer image. An output of the density sensor 27 is inputted to the print CPU 405. The print CPU 405 also controls a voltage applied to the developer roller 21A.

The scan CPU409 controls a CCD driving circuit 410 which drives a CCD 411. A signal from the CCD 411 is outputted to the image forming unit 13.

### Image Quality Maintenance Operation

When the density of the patches 31 detected by the density sensor 27 is higher than a predetermined value, the image forming apparatus 1 carries out an image quality maintenance operation for the developer supply unit 21 corresponding to the dense color.

The density sensor 27 detects the density of the patches 31 on the transfer belt 25. The density sensor 27 can also be configured to detect the density of the patches 31 on the photoconductive drum 22. In this case, the density sensor 27 is installed for each photoconductive drum 22, facing each photoconductive drum 22.

A first image quality maintenance operation is carried out by replacement of a developer. If the developer deteriorates, its charging capability is lowered. As the charging capability is lowered, the potential difference from the electrostatic latent image on the photoconductive drum 22 becomes greater and therefore the developer image becomes denser.

In the image forming apparatus 1, a solid developer image is formed on the photoconductive drum 22 and the developer image is collected by the cleaning unit 26, thus discharging the deteriorated developer. It is desirable that the quantity of the discharged developer is half the quantity of the developer in the developer supply unit 21.

The quantity of the discharged developer can also be changed in accordance with the density of the patches 31. For example, if the density of the patches 31 is higher than a predetermined value, the quantity of the discharged developer can be increased.

Moreover, in the image forming apparatus 1, a fresh developer is supplied to the developer supply unit 21 and then stirred for a predetermined time and charged. This stirring is carried out in the state where a potential is applied to the photoconductive drum 22 and the developer roller 21A. The application of the potential to the photoconductive drum 22 and the developer roller 21A is for the purpose of preventing the developer from being scattered on the photoconductive drum 22 and the like.

A second image quality maintenance operation is carried out by change in contrast potential. Here, the difference between the potential of the electrostatic latent image on the photoconductive drum 22 and the potential of the developer roller 21A is called contrast potential.

In the image forming apparatus 1, the voltage section 21C is controlled to change the developing bias voltage as the potential of the developer roller 21A to the positive side. Thus, the contrast potential is lowered. As the contrast potential is lowered, the quantity of the developer shifting from the developer roller 21A to the electrostatic latent image on the photoconductive drum 22 is reduced. Therefore, the density of the developer image becomes lower.

For example, it is now assumed that the exposure potential as the potential of the electrostatic latent image on the photoconductive drum 22 is −30 V, the charging potential of the photoconductive drum 22 is −600 V and the developing bias voltage is −450 V. In this case, the contrast potential is 420 V.

In the image forming apparatus 1, the voltage section 21C is controlled to change the developing bias voltage to −400 V and thus reduce the absolute value of the developing bias voltage. The contrast potential changes from 420 V to 370 V and its absolute value becomes smaller. Therefore, the developer density of the developer image is lowered.

In the image forming apparatus 1, the first image quality maintenance operation is carried out if the density of the patches 31 is higher than a predetermined value and the absolute value of the contrast potential reaches a preset value even after the image quality maintenance by the second image quality maintenance operation is carried out.

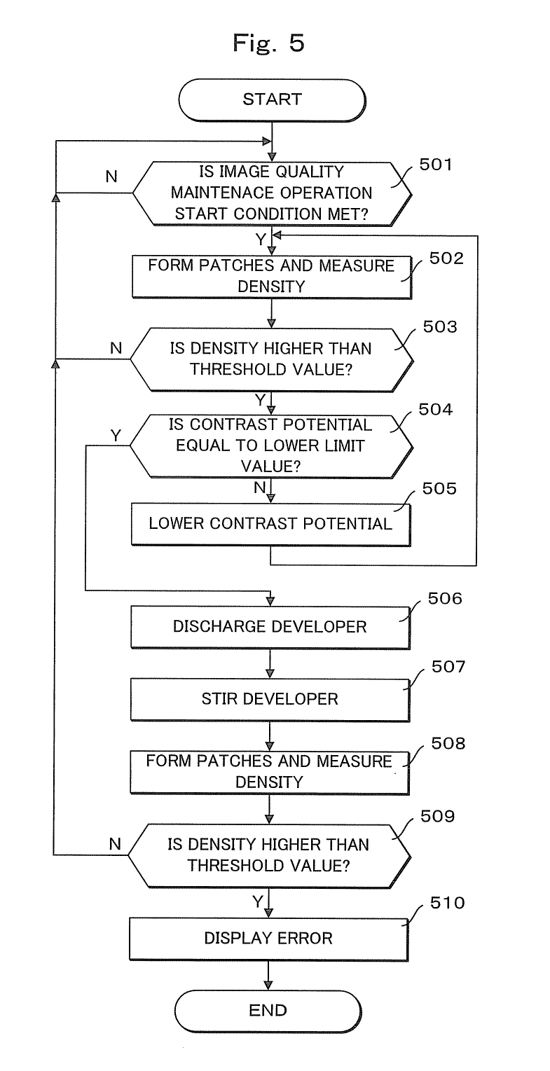

FIG. 5 is a flowchart showing the image quality maintenance operation in the image forming apparatus 1. As shown in FIG. 5, in Act 501, the image forming apparatus 1 determines whether a condition for starting the image quality maintenance operation is met or not. The condition for starting the image quality maintenance operation can be, for example, one of the case where the image forming apparatus 1 is used for the first time, that is, in initial setting, the case where the time period for which image formation is not continuously carried out exceeds a preset time, and the case where the number of sheets on which image formation is continuously carried out exceeds a preset number of sheets. The image forming apparatus 1 proceeds to Act 502 only if the condition for starting the image quality maintenance operation is met. The image forming apparatus 1 returns to Act 501 if the condition is not met.

In Act 502, in the image forming apparatus 1, the patches 31 are formed on the transfer belt 25 and the density of the patches 31 is measured by the density sensor 27.

In Act 503, the image forming apparatus 1 determines whether the density measured by the density sensor 27 is higher than a preset threshold value. The image forming apparatus 1 proceeds to Act 504 if the density measured by the density sensor 27 is higher than the preset threshold value. The image forming apparatus 1 returns to Act 501 if the measured density is equal to or lower than the threshold value.

In Act 504, the image forming apparatus 1 determines whether the contrast potential is equal to a preset lower limit value. If the contrast potential is not equal to the preset lower limit value, the image forming apparatus 1 lowers the contrast potential by a predetermined value in Act 505 and then returns to Act 502. If the contrast potential reaches the preset lower limit value, the image forming apparatus 1 proceeds to Act 506.

In Act 506, the image forming apparatus 1 discharges the developer and supplies a fresh developer to the developer supply unit 21 after the discharge.

In Act 507, the image forming apparatus 1 causes the stirring member 21B to rotate, stir the developer for a predetermined time and thus charge the developer.

In Act 508, in the image forming apparatus 1, the patches 31 are formed again and the density is measured again by the density sensor 27.

In Act 509, the image forming apparatus 1 determines whether the density measured by the density sensor 27 is higher than a preset threshold value. The image forming apparatus 1 proceeds to Act 510 if the density measured by the density sensor 27 is higher than the preset threshold value. The image forming apparatus 1 returns to Act 501 if the measured density is equal to or lower than the threshold value.

In Act 510, the image forming apparatus 1 displays an error on the control panel 403 and ends the processing.

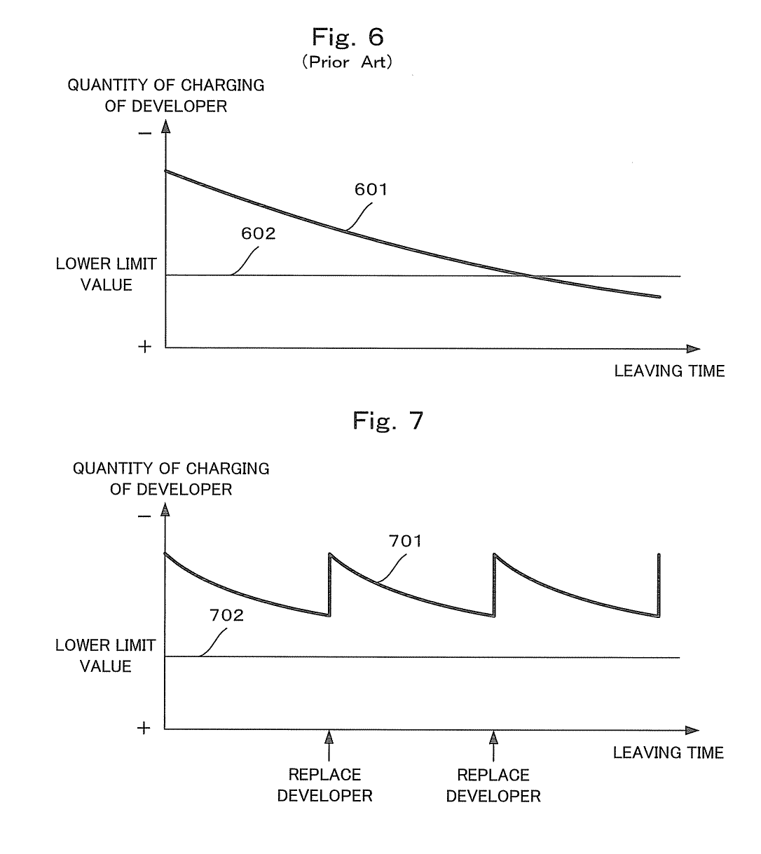

FIG. 6 is a graph showing the relation between the quantity of charging of the developer and the leaving time in a conventional image forming apparatus. In the conventional image forming apparatus, the quantity of charging of the developer becomes lower than an allowable lower limit value 602 with the lapse of time, as indicated by a line 601 in FIG. 6.

FIG. 7 is a graph showing the relation between the quantity of charging of the developer and the leaving time in the image forming apparatus 1 according to this embodiment. In the image forming apparatus 1, the developer is replaced and stirred and thus charged before the quantity of charging of the developer reaches the allowable lower limit value, as indicated by a line 701 in FIG. 7. Therefore, the quantity of charging of the developer does not become lower than the allowable lower limit value.

As described above, the image forming apparatus 1 according to this embodiment has the photoconductive drum which carries an electrostatic latent image, the developer supply unit 21 which supplies a developer to the photoconductive drum 22, the image carrier which carries a developer image, and the density sensor 27 which measures the density of a test print on the image carrier. The image forming apparatus 1 carries out the second image quality maintenance operation to lower the contrast potential when the density of the test print is higher than a predetermined value. When the test print is still dense even if the contrast potential reaches the lower limit value, the image forming apparatus 1 carries out the first image quality maintenance operation to discharge the developer, supply a fresh developer to the developer supply unit 21 and stir and thus charge the developer.

Thus, the image forming apparatus 1 according to this embodiment has an advantage that an image of good quality can be constantly formed.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus which forms an image on a carried recording medium, comprising:
an image carrier which carries an electrostatic latent image;
a developer supply unit having a stirring member which stirs a developer and a developer roller which supplies the developer to the image carrier;
a developer image carrier which carries a developer image that is formed as the developer is supplied to the electrostatic latent image;
a cleaning unit which collects the developer on the image carrier;
a density sensor which measures a density of a test print on the developer image carrier; and
a controller which, if the density of the test print measured by the density sensor is higher than a predetermined value, carries out a first image quality maintenance operation of discharging a part of the developer in the developer supply unit, then supplying a fresh developer to the developer supply unit, and causing the stirring member to stir and charge the supplied fresh developer.

2. The apparatus according to claim 1, wherein the controller further includes a contrast potential controller which executes a second image quality maintenance operation of changing a contrast potential which is a difference between a potential of the electrostatic latent image on the image carrier and a potential of the developer roller, and
if the contrast potential reaches a predetermined lower limit value via the second image quality maintenance operation and the density of the test print measured by the density sensor is higher than a predetermined value, the first image quality maintenance operation is executed.

3. The apparatus according to claim 1, wherein the first image quality maintenance operation is executed at the time of initial setting.

4. The apparatus according to claim 1, wherein the first image quality maintenance operation is executed when a time period for which image formation is not continuously carried out exceeds a preset time.

5. The apparatus according to claim 1, wherein the first image quality maintenance operation is executed when the number of sheets on which image formation is continuously carried out exceeds a preset number of sheets.

6. The apparatus according to claim 1, wherein the first image quality maintenance operation is executed for each color of the developer.

7. The apparatus according to claim 1, wherein in the first image quality maintenance operation, the quantity of the discharged developer is changed in accordance with the density of the test print.

8. The apparatus according to claim 1, wherein in the first image quality maintenance operation, the fresh developer is stirred by the stirring member in the state where a potential is applied to the image carrier and the developer roller.

9. An image forming apparatus which forms an image on a carried recording medium, comprising:
an image carrier which carries a developer image;
a developer supply unit which houses a developer;
a developer image carrier which supplies the developer housed in the developer supply unit to the image carrier and thus forms a developer image;
a density sensor which detects a density of the developer image formed in a predetermined pattern on the image carrier; and
a controller which, in accordance with the density of the developer image detected by the density sensor, forces a part of the developer in the developer supply unit to adhere to the image carrier, thus causes the developer to be consumed, and supplies a fresh developer to the developer supply unit to replace the developer.

10. The apparatus according to claim 9, further comprising a voltage section which applies a developing bias voltage to the developer roller,
wherein the controller adjusts the developing bias voltage, and
if an absolute value of the developing bias voltage reaches a predetermined value and the density of the developer image detected by the density sensor is higher than a predetermined density, a controller, in accordance with the density of the developer image detected by the density sensor, forces a part of the developer in the developer supply unit to adhere to the image carrier, thus causes the developer to be consumed, and supplies a fresh developer to the developer supply unit to replace the developer.

11. An image quality maintenance method for an image forming apparatus which forms an image on a carried recording medium, the method comprising:
if a density of a test print measured by a density sensor is higher than a predetermined density,
a controller for controlling each part of an image forming system, carrying out a first image quality maintenance operation of:
discharging a developer in a developer supply unit;
supplying a fresh developer to the developer supply unit; and
causing a stirring member to stir and charge the supplied fresh developer.

12. The method according to claim 11, wherein a contrast potential controller executes a second image quality maintenance operation of changing a contrast potential which is a difference between a potential of an electrostatic latent image on an image carrier and a potential of a developer roller, and
the controller executes the first image quality maintenance operation if the contrast potential reaches a predetermined lower limit value via the second image quality maintenance operation and the density of the test print measured by the density sensor is higher than a predetermined value.

13. The method according to claim 11, wherein the first image quality maintenance operation is executed at the time of initial setting.

14. The method according to claim 11, wherein the first image quality maintenance operation is executed when a time period for which image formation is not continuously carried out exceeds a preset time.

15. The method according to claim 11, wherein the first image quality maintenance operation is executed when the number of sheets on which image formation is continuously carried out exceeds a preset number of sheets.

16. The method according to claim 11, wherein the first image quality maintenance operation is executed for each color of the developer.

17. The method according to claim 11, wherein in the first image quality maintenance operation, the quantity of the discharged developer is changed in accordance with the density of the test print.

18. The method according to claim 11, wherein in the first image quality maintenance operation, the fresh developer is stirred by the stirring member in the state where a potential is applied to the image carrier and the developer roller.

19. An image quality maintenance method for an image forming apparatus which forms an image on a carried recording medium, the method comprising:
if a density of a test print on an image carrier measured by a density sensor is higher than a predetermined density,
a controller for controlling each part of an image forming system, carrying out a first image quality maintenance operation of:
causing a part of a developer in a developer supply unit to adhere to the image carrier and thus causing the developer to be consumed;
supplying a fresh developer to the developer supply unit; and
causing a stirring member to stir the supplied fresh developer and thus charge the developer.

20. The method according to claim 19, wherein the controller adjusts a developing bias voltage of a voltage section which applies the developing bias voltage to a developer roller, and
executes the first image quality maintenance operation if an absolute value of the developing bias voltage reaches a predetermined value and the density of the test print detected by the density sensor is higher than a predetermined density.
